(19) United States
(12) Patent Application Publication
(10) Pub. No.: US 2025/0196515 A1
(43) Pub. Date: Jun. 19, 2025

(54) RECORDING APPARATUS

(71) Applicant: CANON KABUSHIKI KAISHA, Tokyo (JP)

(72) Inventor: SHO NAKAMURA, Tokyo (JP)

(21) Appl. No.: 18/973,764

(22) Filed: Dec. 9, 2024

(30) Foreign Application Priority Data
Dec. 14, 2023 (JP) 2023-211577

(51) Int. Cl. B41J 11/00; B41J 2/21; B41J 15/04

(52) U.S. Cl. CPC B41J 11/00242; B41J 2/2103; B41J 2/2117; B41J 15/04

(57) ABSTRACT

A recording apparatus includes a recording unit that records an image on a continuous recording medium, a conveyance unit that conveys the continuous recording medium in a first direction, a fixing unit that fixes the image to the continuous recording medium by heating the image, and an inspection unit that inspects the image fixed on the continuous recording medium by the fixing unit, wherein the conveyance unit stops conveyance of the continuous recording medium based on a result of inspection of the image performed by the inspection unit, and, after a temperature of the fixing unit is lowered to a temperature lower than or equal to a predetermined temperature, rewinds the recording medium in a second direction opposite to the first direction so that the image reaches a predetermined position.

### BACKGROUND

### Field

The present disclosure relates to a recording apparatus.

### Description of the Related Art

There has been known recording apparatuses that record images with recording agents applied on recording media. For a continuous sheet used as a recording medium, recording apparatuses typically have a configuration where the continuous sheet is wound at a paper discharge unit and supplied from a paper feed unit to a recording unit. During a printing inspection in some recording apparatuses, inspections are performed regarding whether images recorded on recording media are as intended by users.

Japanese Patent No. 6834325 discloses that if a formed image is determined to be an image for inspection, the stop position of the image is changed to an observable position. The configuration in Japanese Patent No. 6834325 stops the conveyance of the image for inspection between a fixing unit for fixing images and the winding unit. Thus, when an image is recorded subsequent to the image for inspection on the recording medium, the conveyance will be stopped with the subsequent image left in the fixing unit.

In such a case, the subsequent image will remain in the fixing unit during the inspection of the image for inspection. The continuous heating at the fixing unit can affect the subsequent image, which is no longer usable as a recorded product.

### SUMMARY

According to an aspect of the present disclosure, a recording apparatus includes a recording unit configured to record an image on a continuous recording medium, a conveyance unit configured to convey the continuous recording medium in a first direction, a fixing unit configured to fix the image to the continuous recording medium by heating the image, and an inspection unit configured to inspect the image fixed on the continuous recording medium by the fixing unit, wherein the conveyance unit stops conveyance of the continuous recording medium based on a result of inspection of the image performed by the inspection unit, and, wherein after a temperature of the fixing unit is lowered to a temperature lower than or equal to a predetermined temperature, the conveyance unit rewinds the continuous recording medium in a second direction opposite to the first direction so that the image reaches a predetermined position.

Further features of the present disclosure will become apparent from the following description of exemplary embodiments with reference to the attached drawings.

### BRIEF DESCRIPTION OF THE DRAWINGS

FIG. 1 is an outline diagram of a recording apparatus according to an exemplary embodiment.

FIG. 2 is a block diagram of the control configuration of the recording apparatus according to the present exemplary embodiment.

FIG. 3 illustrates an example of images recorded on a recording medium according to the present exemplary embodiment.

FIG. 4 is a flowchart illustrating a procedure of recording processing according to the present exemplary embodiment.

FIG. 5 is a flowchart illustrating a detailed procedure of a stop determination according to the present exemplary embodiment.

FIG. 6 is a flowchart illustrating a detailed procedure of rewinding processing according to the present exemplary embodiment.

FIG. 7 is a schematic diagram illustrating positions of pages in the recording apparatus when an image is determined to correspond to a recording failure according to the present exemplary embodiment.

FIGS. 8A and 8B are schematic diagrams each illustrating performing rewinding processing on the recording medium according to the present exemplary embodiment.

### DESCRIPTION OF THE EMBODIMENTS

An exemplary embodiment of the present disclosure will now be described with reference to the accompanying drawings.

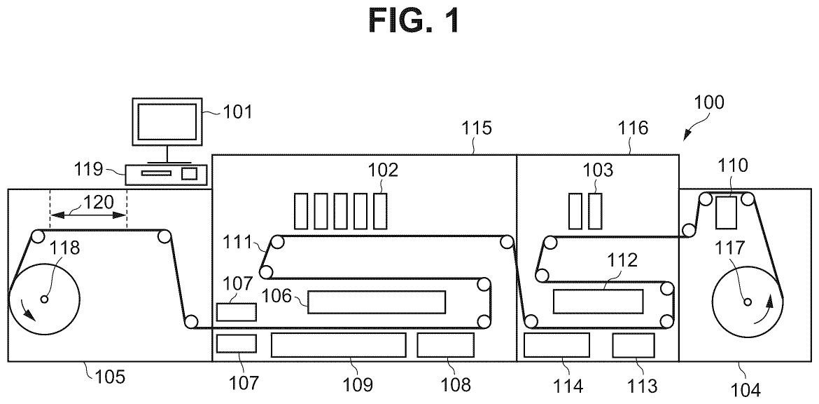

FIG. 1 illustrates an example of the apparatus configuration of a recording apparatus. A recording apparatus 100 can continuously print on a continuous recording medium 111. The continuous recording medium is a recording medium in a form used for continuous recording of a plurality of images, such as a rolled recording medium and fan-fold paper. The recording apparatus 100 includes a paper feed unit 104 for conveying the recording medium 111, a first recording unit 116, a second recording unit 115, and a paper discharge unit 105.

The paper feed unit 104 includes an unwinding roll unit 117 and a skew correction unit 110. The recording medium 111 is unwound from its roll by the rotation of the unwinding roll unit 117, and is conveyed to the first recording unit 116. If the recording medium 111 being conveyed is skewed, the conveying direction of the recording medium 111 is adjusted by the skew correction unit 110 and then the recording medium 111 is conveyed to the first recording unit 116.

The first recording unit 116 includes a recording head 103, a heating device 112, and cooling devices 113 and 114. The recording head 103 ejects special color inks, such as white color and fluorescent color, to the recording medium 111. The image recorded by the recording head 103 is heated by the heating device 112 as a first fixing unit to be dried and fixed, and is cooled by the cooling devices 113 and 114, and then is conveyed to the second recording unit 115.

The second recording unit 115 includes a recording head 102, a heating device 106, cooling devices 108 and 109, and connection scanner devices 107. The second recording unit 115 is disposed downstream of the first recording unit 116 in the conveyance direction of the recording medium. The recording head 102 records an image by ejecting inks of basic colors, such as cyan (C), magenta (M), yellow (Y), and black (K), to the recording medium 111. The image recorded by the recording head 102 is heated by the heating device 106 as a second fixing unit to be dried and fixed, and is cooled by the cooling devices 108 and 109, and then conveyed to the paper discharge unit 105. The paper discharge unit 105 includes a winding roll unit 118 for winding the recording medium 111 recorded by the first recording unit 116 and the second recording unit 115. The connection scanner devices 107 are devices configured to determine whether the image recorded on the recording medium 111 has a defect on it by reading the image with a scanner.

When the connection scanner devices 107 detects a defect, the conveyance of the recording medium 111 is stopped. In addition to a method of reading images with a scanner, a method can be employed of inspecting images being captured with a camera, or of monitoring states of ink ejected from the nozzles.

When an image recorded on the recording medium 111 is visually inspected, the target image is stopped at an image confirmation position 120 in the paper discharge unit 105. It is desirable to dispose the image confirmation position 120 to be exposed external to the image confirmation position 120 or cover the image confirmation position 120 with a case made of transparent material in the vicinity of the image confirmation position to enable the recording medium 111 to be viewed from external to the image confirmation position 120.

The paper feed unit 104, the first recording unit 116, the second recording unit 115, and the paper discharge unit 105 each include a plurality of conveyance rollers to convey the recording medium 111 in addition to the above-described configuration.

A printing operation according to the present embodiment will now be described. After the recording medium 111 is placed on the paper feed unit 104, a user sends the recording medium 111 to pass the recording medium 111 through the internal configuration of the paper feed unit 104, the first recording unit 116, the second recording unit 115, and the paper discharge unit 105, and winds the recording medium 111 around the winding roll unit 118. The recording medium 111 can be placed automatically, not manually. In this state, a user inputs a print job to the recording apparatus 100 via a personal computer (PC) 119 connected to the recording apparatus 100. Selection of the print start button displayed on the UI operation panel 101 included in the controlling PC 119 starts the printing performed by the recording apparatus 100.

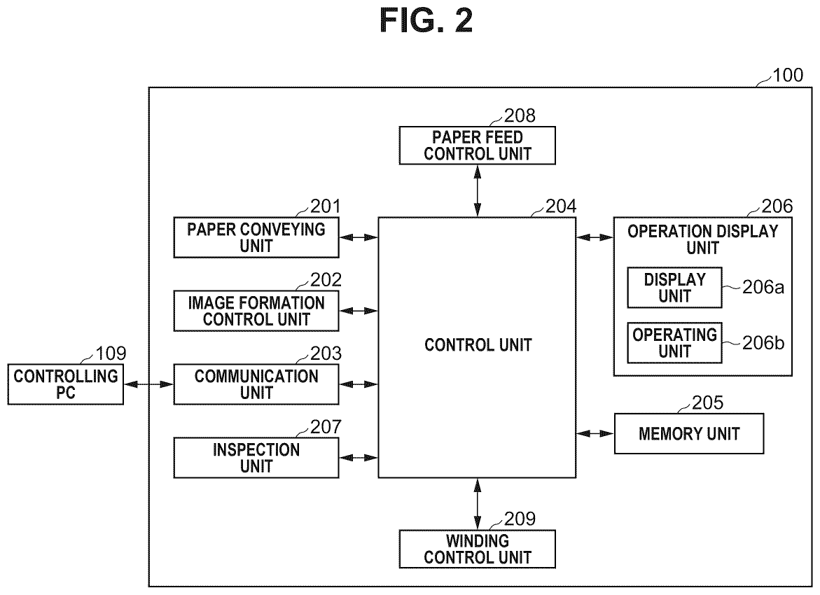

FIG. 2 is a block diagram of the control configuration of the recording apparatus 100. The recording apparatus 100 includes a paper conveying unit 201, an image forming unit 202, a communication unit 203, a control unit 204, a memory unit 205, an operation display unit 206, an inspection unit 207, a paper feed control unit 208, and a winding control unit 209. The paper conveying unit 201 is a conveyance mechanism for the recording medium 111, and controls the driving of the above-described conveyance rollers. The paper feed control unit 208 controls the rotational driving force of the unwinding roll unit 117, and the winding control unit 209 controls the rotational driving force of the winding roll unit 118. The image forming unit 202 forms an image on the recording medium 111 by controlling the driving of the recording head 102 and the recording head 103 based on the print data for which an output instruction is received.

The communication unit 203 includes a communication control card, such as a local area network (LAN) card, for example. The communication unit 203 transmits and receives various types of data to and from the controlling PC 119 connected to a communication network, such as LAN and wide area network (WAN). The control unit 204 includes a central processing unit (CPU) and a random access memory (RAM). The CPU of the control unit 204 reads various types of programs, such as a system program and a processing program stored in the memory unit 25, loads the programs into the RAM, and performs various types of processing based on the loaded programs. For example, the control unit 204 can perform image forming processing to execute an image forming job (hereinafter referred to as a “job”) based on a user's instruction. In addition, the control unit 204 provides instructions to functional blocks to control the functional blocks.

The memory unit 205 includes a nonvolatile semiconductor memory (so-called a flash memory), and a hard disk drive (HDD). The memory unit 205 stores various types of programs, such as a system program and a processing program, to be executed in the control unit 204, and various types of data for execution of these programs.

The operation display unit 206 is, for example, a not-illustrated liquid crystal display (LCD) equipped with a touch panel including a display unit 206a and an operating unit 206b. The display unit 206a displays various types of information related to the recording apparatus 100 on a display screen based on display control signals input from the control unit 24. The operating unit 206b includes various types of operation keys, such as a numeric keypad and a start key, receives various types of input operation from a user, and outputs the operation signals to the control unit 204. The operation display unit 206 is used in setting job information when performing a print job, for example. A user can set various types of conditions, such as the type of the recording medium 111 and information about the printing speed, the number of sheets to be printed, the number of copies to be printed, a printing length, a printing weight, and a printing diameter. The operation display unit 206 can also display the amount of ink stored in a not-illustrated ink tank that stores ink to be supplied to the recording heads 102 and 103, and notify errors in the recording apparatus 100.

When image forming processing is performed on the recording medium 111 in the recording apparatus 100, a user generates data for a job and configures print settings for the job and the numbers of delivery rolls on the controlling PC. These pieces of information are transmitted via a communication network to the communication unit 203. The control unit 204 receives the data for the job and a job ticket including the print settings information about the job and the information about the delivery rolls via the communication unit 203. The inspection unit 207 inspects images scanned by the connection scanner device 107.

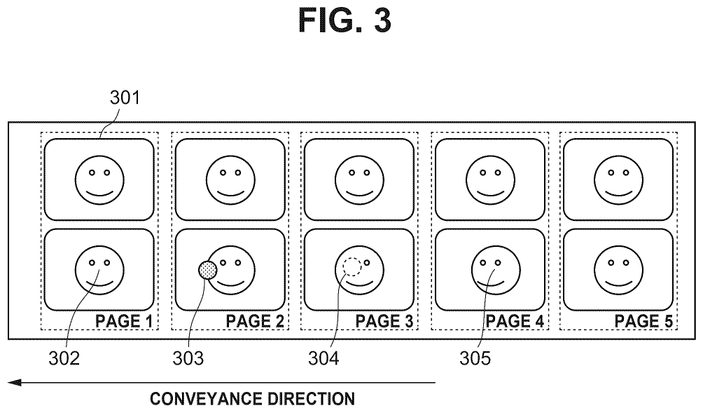

FIG. 3 illustrates an example of images recorded on the recording medium 111. An image is recorded on a label region 301. FIG. 3 illustrates an example where two images are disposed in a width direction of a sheet, and the regions indicated by a dotted line including two images corresponds to one page. The present disclosure is not limited to this example, and four images can correspond to one page. An image 302 is an example of an image produced by the recording being performed appropriately according to the print job, and images 303 to 305 are examples of images produced by the recordings not being performed appropriately, each of which is determined to correspond to a recording failure.

The image 303 is an example of an image determined to correspond to a recording failure due to some stain in the label region. Such stain is caused by adhesion of ink, dust or paper dusts, or damage to the recording medium 111 during conveyance. The image 304 is an example of image of which a part is missing caused by non-ejection of ink due to clogging of some nozzles of the recording head 102 or 103, for example. The image 305 is an example of an image of which a part is not aligned with the label region due to a misalignment during ink ejection from the recording head 102 or 103 to the recording medium 111. Image misalignments are caused by, for example, an error in the amount of conveyance of the recording medium 111 and a deviation from the ejection position or the ejection timing of ink. The recording failures described above are merely examples and are not limiting. For example, an illegible printed barcode or QR® code can be determined to correspond to a recording failure. When a measured value from a tonality measurement conducted on an image with a colorimeter is not a predetermined value, the measured value can be determined to indicate a recording failure.

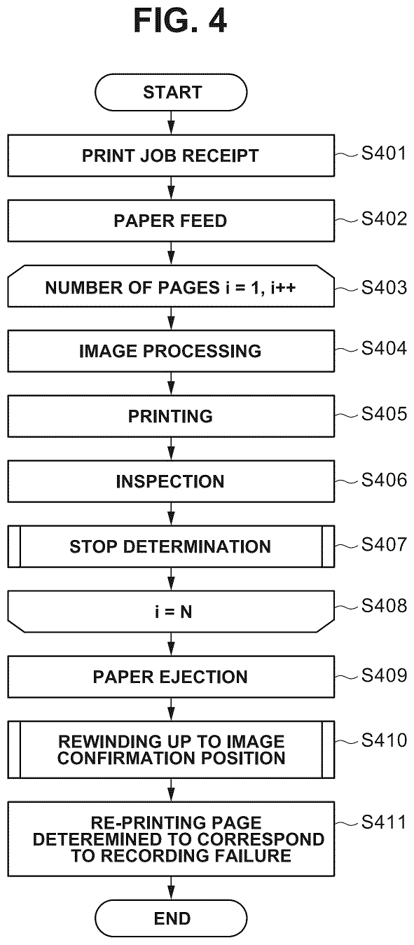

FIG. 4 is a flowchart illustrating a procedure of recording processing on the recording medium 111. In step S401, the control unit 204 receives print the settings of a job from the controlling PC 119. In step S402, the control unit 204 instructs the paper feed control unit 208 to feed the paper corresponding to the length of the number of sheets to be printed, and the paper feed unit 104 starts the feed the paper of the length of the recording medium 111. In step S403, the paper feed unit 104 starts counting the number of pages of the job based on the length of the conveyed paper.

In step S404, the CPU of the control unit 204 performs image processing to cause the image forming unit 202 to perform the printing, and based on the result of the image processing, in step S405, the image forming unit 202 drives the recording head 102 and the recording head 103 to perform the recording on the recording medium 111.

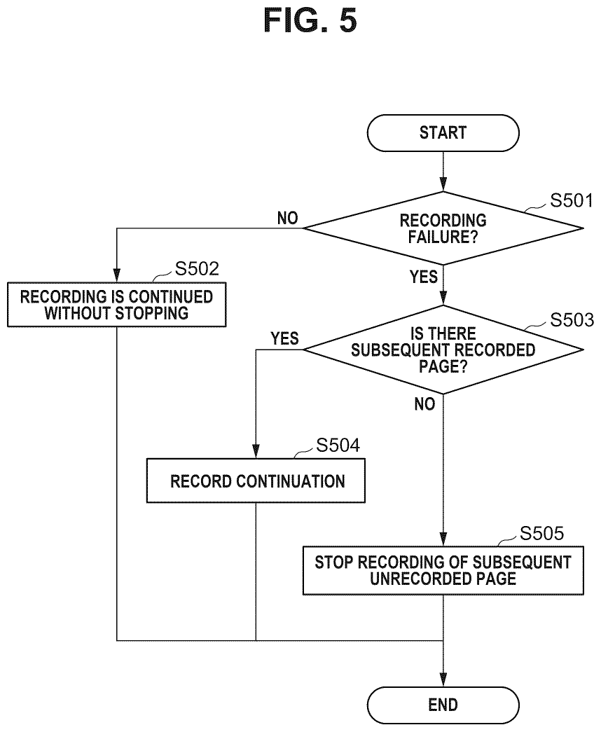

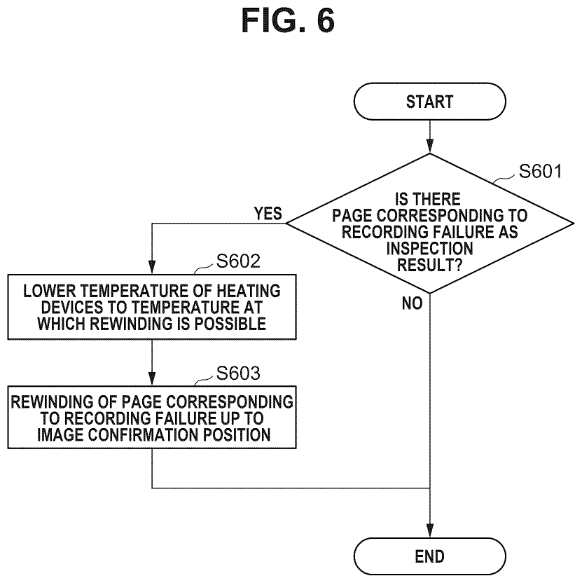

In step S406, the inspection unit 207 inspects each page of the recorded images based on data received from the connection scanner device 107. In step S407, the control unit 204 determines whether to stop the conveyance based on the result of the inspection in step S406, the stop determination of which will be described below in detail with reference to FIG. 5. The processing from step S403 to S407 is repeated until the number of pages in the print job reaches N pages in step S408. When the recording of the N pages is finished, in step S409, the winding roll unit 118 controlled by the winding control unit 209 sequentially winds the recording medium 111 to discharge the recording medium. In step S410, the control unit 204 determines whether to perform a rewinding, and the detail thereof will be described below with reference to FIG. 6. When the rewinding processing is performed in step S410, the image forming unit 202 drives the recording heads 102 and 103 and re-prints the page determined to correspond to a recording failure in step S406. In step S411, settings can be configured so that re-printing (re-recording) of the page(s) visually determined to be not defective by the user out of the pages determined to correspond to a recording failure in step S406. In addition, as described below, when the conveyance is stopped in step S407, the temperature of the heating device 106 is lowered. To perform re-printing, control is performed to re-raise the temperature of the heating device 106, and then the procedure in FIG. 4 is started from step S401.

FIG. 5 is a detailed procedure of stop determination (step S407) in FIG. 4. When step S407 starts in FIG. 4, the processing proceeds to step S501, and the control unit 204 determines whether the result of the inspection performed in step S406 in FIG. 4 indicates a recording failure. If no recording failure is indicated (NO in step S501), the processing proceeds to step S502. In step S502, the recording is continued without stopping the conveyance of the recording medium 111.

If the result indicates a recording failure in step S501 (YES in step S501), the processing proceeds to step S503. In step S503, the control unit 204 determines whether there is a page subsequent to any page determined to correspond to a recording failure is recorded. In one example, the determination is made depending on whether a print instruction is issued to the image forming unit 202 by the control unit 204. If there is a page subsequent to any page determined to correspond to a recording failure is recorded (YES in step S503), the processing proceeds to step S504. In step S504, the control unit 204 continues the recording without stopping the recording in the job. This prevents the stop of the conveyance of the recording medium 111 while the subsequent recorded page remains within the heating device 106 or the heating device 112. If the recorded page remains within the heating device 106 or the heating device 108, the continuous heat can affect the image quality of the recorded page left within the heating device 106 or the heating device 112. Avoidance of this situation can prevent the situation where changed image quality makes it impossible to collect the recorded page as a printed product from occurring. In step S503, if it is determined that there is no subsequent printed page (NO in step S503), the process proceeds to step S505. In step S505, the control unit 204 instructs the image forming unit 202 to stop the printing of subsequent unprinted pages, and stops the conveyance of the recording medium 111. This is because if there is no recorded page subsequent to any page determined to correspond to a recording failure, no undried image will remain withing the heating device 106 or the heating device 112 even when the conveyance of the recording medium 111 is stopped.

If it is determined that there is subsequent printed page (YES in step S503), the printing is continued as described above. However, the printing can be stopped halfway without continuing. This switch can be set by a user as an item on the operating unit 206b.

FIG. 6 illustrates a detailed procedure of rewinding processing (in step S410) of FIG. 4. In step S601, the control unit 204 determines whether there is a page corresponding to a recording failure among the recorded pages. If there is no page corresponding to a recording failure (NO in step S601), no rewinding processing is performed and the recording processing ends. If there is a page corresponding to a recording failure (YES in step S601), the processing proceeds to step S602.

In step S602, the control unit 204 performs a control to lower the heating temperatures of the heating devices 106 and 112. In this process, the temperatures of the heating devices 106 and 112 are lowered to a temperature or below at which image deterioration will not occur even when a recorded image re-enters a heating device by a rewinding of the recording medium 111. The heating devices 106 and 112 are each provided with a not-illustrated temperature sensor used to monitor the temperature inside each heating device on a regular basis. During the recording of images on the recording medium 111, the temperatures of the heating devices 106 and 112 are set to about 90 degrees centigrade, and in step S602, the temperatures are lowered to about 50 degrees centigrade. The temperatures of the heating devices 106 and 112 during the image recording on the recording medium 111 and the lowered temperature in step S602 can be set based on the type of the recording medium 111 as appropriate.

In step S602, when the temperatures of the heating devices 106 and 112 are lowered to the predetermined temperature, the processing proceeds to step S603. The recording medium 111 is rewound in the direction opposite to the conveyance direction until a page corresponding to a recording failure reaches the image confirmation position 120, and the page is subject to visual inspection by a user. After the visual inspection is finished in step S603, the processing proceeds to step S411 in FIG. 4.

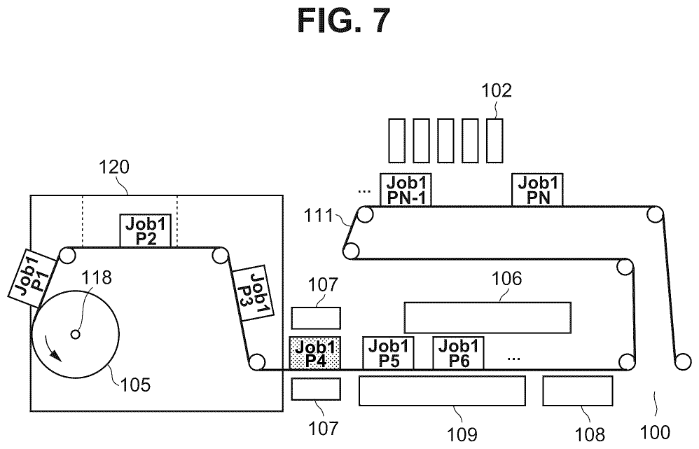

FIG. 7 is a schematic diagram illustrating positions of pages in the recording apparatus 100 when there is an image determined to correspond to a recording failure in step S501 of FIG. 5. Here, the total number of pages is N from a job 1-P1 to a job 1-PN. FIG. 7 illustrates an example where the job 1-P4 is determined to correspond to a recording failure. In this case, recordings in the job are finished from the job 1-P5, the subsequent page of the job 1-P4, up to the further subsequent job 1-PN-1, and a recording is not yet performed on the job 1-PN. In the present exemplary embodiment, since the recording is finished on the job 1-P5 subsequent to the job 1-P4, the recording on the job 1-PN is continued.

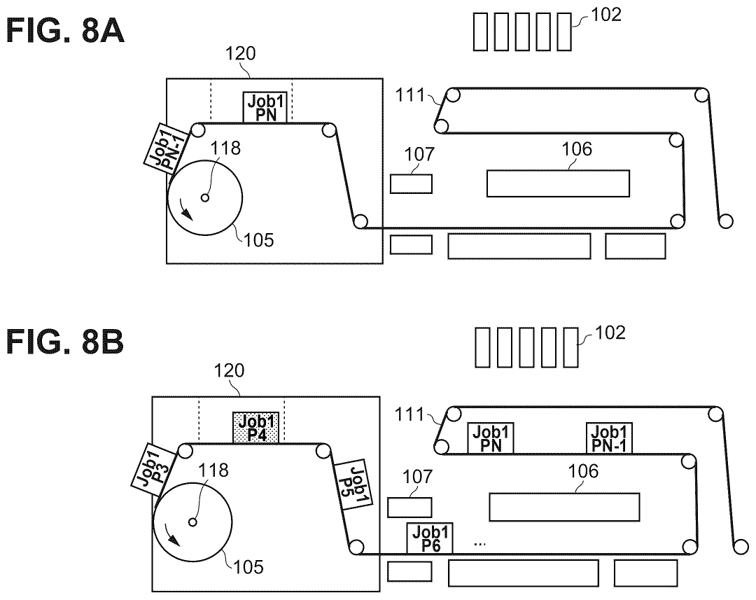

FIGS. 8A and 8B are schematic diagrams illustrating performing rewinding processing on the recording medium 111 in step S603 of FIG. 6. FIG. 8A illustrates a situation where the printing is finished up to the job 1-PN, and the conveyance is stopped with the inspection completed by the connection scanner device 107. At this timing, all the images from the job 1-P1 to the job 1-PN are stopped through the heating device 106. Thereafter, as illustrated in FIG. 8B, the temperatures of the heating devices 106 and 112 are lowered, and the recording medium 111 is rewound until the job 1-P4 determined to corresponding to a recording failure reaches the image confirmation position 120.

The above-described configuration enables a determination whether there is an image corresponding to a recording failure while recording is being performed on a continuous sheet, and can prevent the image subsequent to the image corresponding to a recording failure from remaining within the heating device. This configuration can prevent the situation where the images other than an image corresponding to a recording failure will be excessively heated, resulting in deteriorated quality of an image, which cannot be collected as a printed product. Consequently, the deterioration of the quality of the pages that do not correspond to a recording failure can be prevented while a page corresponding to a recording failure can be subject to re-printing.

According to the present disclosure, in recording on a continuous sheet, the deterioration of the quality degradation of pages can be prevented even when an image inspection is performed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-211577, filed Dec. 14, 2023, which is hereby incorporated by reference herein in its entirety.

What is claimed is:

1. A recording apparatus comprising:
a recording unit configured to record an image on a continuous recording medium;
a conveyance unit configured to convey the continuous recording medium in a first direction;
a fixing unit configured to fix the image to the continuous recording medium by heating the image; and
an inspection unit configured to inspect the image fixed on the continuous recording medium by the fixing unit,
wherein the conveyance unit stops conveyance of the continuous recording medium based on a result of inspection of the image performed by the inspection unit, and,
wherein after a temperature of the fixing unit is lowered to a temperature lower than or equal to a predetermined temperature, the conveyance unit rewinds the continuous recording medium in a second direction opposite to the first direction so that the image reaches a predetermined position.

2. The recording apparatus according to claim 1, wherein in a case where the inspection unit determines that the image corresponds to a failure, the conveyance unit rewinds the continuous recording medium in the second direction so that the image reaches the predetermined position.

3. The recording apparatus according to claim 1,
wherein the recording unit records the image on the continuous recording medium based on a job received by the recording apparatus, the job including information related to the image, and
wherein in a case where the inspection unit determines the image to correspond to a failure in the job that includes information related to a plurality of images including the image, when a second image is being recorded, the second image being included in the job and to be recorded on the continuous recording medium after the image, the conveyance of the continuous recording medium by the conveyance unit is stopped after the recording of the second image is finished, the temperature of the fixing unit is lowered to a temperature lower than or equal to the predetermined temperature, and then the continuous recording medium is rewound in the second direction opposite to the first direction by the conveyance unit so that the image reaches the predetermined position.

4. The recording apparatus according to claim 3, wherein in a case where the recording of the second image included in the job and to be recorded on the continuous recording medium after the image is finished, after recording of all images included in the job is finished, the conveyance of the continuous recording medium by the conveyance unit is stopped, the temperature of the fixing unit is lowered to a temperature lower than or equal to the predetermined temperature, the continuous recording medium is rewound in the second direction opposite to the first direction by the conveyance unit so that the image reaches the predetermined position.

5. The recording apparatus according to claim 3, wherein the predetermined temperature is a temperature at which the second image does not deteriorate when rewinding by the conveyance unit is stopped in a state in which the second image is within the fixing unit.

6. The recording apparatus according to claim 3, wherein in a case where the inspection unit determines that the image corresponds to a failure, the continuous recording medium is rewound in the second direction opposite to the first direction by the conveyance unit, and then the image is re-recorded on the recording medium.

7. The recording apparatus according to claim 1, wherein the predetermined position is a position enabling a user to visually inspect the image.

8. The recording apparatus according to claim 1,
wherein the predetermined position is a position enabling a user to visually inspect the image, and
wherein in a case where the inspection unit determines that the image corresponds to a failure, the continuous recording medium is rewound in the second direction opposite to the first direction by the conveyance unit and undergoes a user's visual inspection, and in a case where the user inputs to the recording apparatus a setting for not performing the re-recording, the re-recording is not performed.

9. The recording apparatus according to claim 1,
wherein the recording unit includes:
a first recording unit; and
a second recording unit disposed downstream of the first recording unit in the first direction, and
wherein the fixing unit includes:
a first fixing unit configured to heat the image recorded by the first recording unit; and
a second fixing unit configured to heat the image recorded by the second recording unit.
